(19) United States
(12) Patent Application Publication
(10) Pub. No.: US 2017/0137718 A1
(43) Pub. Date: May 18, 2017

(54) Composition formed of Bitumen Bases for the Manufacture of Bitumen Comprising a Slurry Residue

(71) Applicant: TOTAL RAFFINAGE CHIMIE, Courbevoie (FR)

(72) Inventors: Christophe Bolliet, Lyon (FR); Gloria Vendrell, Le Havre (FR); Matthieu Seguela, Irigny (FR)

(21) Appl. No.: 15/127,431

(22) PCT Filed: Mar. 24, 2015
(86) PCT No.: PCT/EP2015/056229

§ 371 Date: Sep. 20, 2016

(30) Foreign Application Priority Data
Mar. 27, 2014 (FR) 1452614

(51) Int. Cl. C10C 3/00; C10G 49/12; C10G 7/06; C08L 95/00

(52) U.S. Cl. CPC C10C 3/005; C08L 95/00; C10G 49/12; C10G 7/06; C10G 2400/16

(57) ABSTRACT

The invention relates to a composition formed of bitumen bases which comprises at least from 70% to 99% by weight of at least one bitumen base having a penetrability at 25° C. of less than or equal to 220.10-1 mm and a softening point of greater than or equal to 35° C. and from 1% to 30% by weight of at least one slurry residue resulting from a slurry-phase hydroconversion process. The slurry residue may have a penetrability at 25° C. of less than or equal to 50.10-1 mm and a softening point of greater than or equal to 50° C. Embodiments of the invention make it possible to upgrade a final vacuum residue slurry for use in the manufacture of a road bitumen.

### TECHNICAL FIELD

The present invention belongs to the field of bitumens, in particular intended for road construction or civil engineering. The present invention relates to a composition formed of bitumen bases comprising a first bitumen base and a second base which is a residue resulting from a slurry-phase (in form of a suspension) hydroconversion process.

Another subject matter of the present invention is the use of a residue resulting from a slurry-phase hydroconversion process in a bitumen.

### STATE OF THE ART

Bitumen is the main hydrocarbon constituent used in the field of road construction or civil engineering. A bitumen can be defined as being a mixture of several “bitumen bases”. Two or more bitumen bases can be mixed to form a composition formed of bitumen bases. A composition formed of bitumen bases can form a bitumen. Two or several compositions formed of bitumen bases can also be mixed in order to obtain a bitumen.

In order to produce “bitumen bases”, crude oils homologated to produce bitumen (named “bruts dits “a bitumes”” in French) are normally selected as a function of their ability to produce the said bases. Thus, among all the crude oils referenced, only less than 10% make it possible to produce “bitumen bases”. The said bases are generally obtained from residues resulting from the atmospheric and/or vacuum distillation of crude oil. The main criteria for choosing the crude oils homologated to produce bitumen are:
the technical characteristics of the bitumen bases resulting from these crude oils: penetrability, viscosity, softening point, and the like,
the appropriateness with refinery plants, in particular the yields with respect to the cut temperatures of the vacuum distillations.

The production of bitumens from crude oils homologated to produce bitumen thus requires operating the plants for a predetermined period of time and adapting them to these specific crude oils, which increases the operational costs.

It is also known to use residues resulting from a visbreaking process as bitumen base, the objective then being to have a base available at a low cost. However, the properties of these visbroken residues do not make them particularly desired products. This is because it is found that the incorporation of these visbroken residues does not improve the properties of the bitumens.

It is also possible to use, as bitumen base, residues resulting from the hydrocracking process described in Patent U.S. Pat. No. 4,904,305 of Nova Husky Research Corporation, also known as “H-Oil” process. The product obtained from this residue is an unfinished product which can be used as additive having the effect of preventing the stripping of a bituminous binder when it is incorporated in a bitumen but without a specific property with regard to the hardness and the viscosity. In other words, the product obtained from this residue is not a bitumen base within the meaning of the present invention.

In order to be able to be used in the field of road construction or civil engineering, bitumens have to exhibit certain physicochemical properties. One of the most important properties is the hardness of the bitumen; at the temperatures of use, the hardness must be sufficiently high to prevent the formation of ruts caused by traffic. Another very important characteristic is the viscosity of the bitumen; the bitumen must be sufficiently fluid at the lowest possible temperatures in order to allow it to be applied and to limit the emissions of fumes during its application. The use of a bitumen base thus necessitates combining both the hardness of the bitumen at ambient temperature and a low viscosity under hot conditions.

One way of adjusting the hardness of the bitumens is to employ expensive processes:
After atmospheric distillation of the crude oils homologated to produce bitumen, a vacuum distillation of the residue is carried out by increasing the cut temperature or by operating at a lower pressure, so as to remove the light fractions. However, this technique is not always sufficiently effective and the heavy fractions are never completely devoid of light fractions.
A second means for hardening a bitumen is to blow it. Blown bitumens are manufactured in a blowing plant by passing a stream of air and/or of oxygen through a bitumen which it is desired to harden. This operation can be carried out in the presence of an oxidation catalyst, for example polyphosphoric acid. Generally, the blowing is carried out at high temperatures, of the order of 200 to 300° C., for relatively long periods of time, typically of between 30 minutes and 2 hours, continuously or batchwise. This blowing process exhibits a number of disadvantages:
the manufacture of blown bitumen requires a blowing plant specifically provided for this purpose,
the viscosity of the blown bitumen at a given temperature is greater than that of the bitumen before blowing, which requires heating the blown bitumen to a temperature greater than that of a non blown bitumen of the same type in order to allow it to be applied, which increases the energy costs and requires the use of additional protection for the applicators.
A third means for hardening a bitumen is to add polymers to it. These polymers also make it possible to improve the cohesion and the elastic properties of the bitumen. These characteristics are thus markedly improved at the temperatures of use. However, under hot conditions, the addition of polymers to the bituminous composition generally results in an increase in the viscosity of the bituminous composition. In order to be able to be applied to the carriageway, the bitumen to which polymers have been added will thus have to be heated to an application temperature greater than that of a bitumen of equivalent type devoid of polymers.

### DESCRIPTION OF THE INVENTION

There thus exists a need for a composition formed of bitumen bases which exhibits advantageous characteristics of hardness and of viscosity and which is available at a reduced cost.

It is known to a person skilled in the art to upgrade the residue resulting from the slurry-phase hydroconversion process, also known as slurry residue, by a gasification process which makes possible the production of hydrogen and the recovery of certain metals (nickel, vanadium or any other metal present in the feedstock). Nevertheless, the economic value of this treated residue is zero, indeed even negative.

The said residues can also be upgraded as solid fuel in the form of pellets (granules). However, the said solid fuel has a residual value which is slight and even lower than the value of petroleum coke. Furthermore, the quality of the pellets obtained is not very good due to the formation of filaments during the combustion of the said pellets.

It has been discovered, unexpectedly, that the incorporation, as bitumen base, of residues resulting from a slurry-phase hydroconversion process makes it possible to produce compositions formed of bitumen bases and thus bitumens, in particular road bitumens, which exhibit improved properties in terms of viscosity. This improvement exhibits the advantage of making it possible to apply the said bitumen at a lower temperature and thus to prevent the formation of bitumen vapours which require the use of additional protection for the applicators and increased energy costs.

Furthermore, the incorporation of slurry residue as bitumen base makes it possible to produce compositions formed of bitumen bases which exhibit particularly advantageous characteristics of hardness.

Thus, the use of slurry residue as bitumen base makes it possible to obtain two properties which are particularly desired in a composition formed of bitumen bases: hardness and viscosity.

In order to make things easier to understand, the following terms will be defined:

Bitumen base or base: according to the invention, a bitumen base or base is regarded as being the product resulting from a refining process (atmospheric distillation, vacuum distillation, and the like). It is an unfinished product in the sense that several bitumen bases are mixed to form a bitumen.

Normally, a bitumen base can be produced by refining a crude oil, in particular a crude oil homologated to produce bitumen, which is heated to 300° C., partially vaporized in an oven and transferred into an atmospheric distillation column in which the separation of the different fractions is carried out. The lightest vaporize while the heaviest (atmospheric residue) remain at the column bottom and pass into a second heat exchanger before treatment in a vacuum distillation column. Finally, the bitumen base is recovered at the bottom of this vacuum distillation column. The bitumen base corresponds, for example, to the 560° C.+ cut of the vacuum distillation.

Additional processes can be used (blowing, deasphalting, and the like) so as to adjust the properties of these bases.

Several bitumen bases, treated or not treated after vacuum distillation, are normally mixed in order to form a bitumen with the desired properties, such as hardness.

Bituminous binder or bitumen: this term defines a finished product which is a mixture of several bitumen bases. This mixture of several bitumen bases makes it possible to formulate a bituminous binder in order to obtain the desired property relating to a specific use.

Categorization of the road bitumens: it is possible, as a function of their properties and according to standardized measurements, to classify road bitumens into six groups of road applications:
Category 1—“Pure” bitumens, that is to say bitumens not modified by additives or polymers. They are employed for the construction and maintenance of road carriageways or covered carriageways. By way of example, the grades belonging to this category 1 are the 20/30, 35/50, 50/70, 70/100 and 160/220 grades, classified according to their penetrability at 25° C. (measured according to the EN 1426 method) and their RBT softening points (Standard EN 1427), respectively 55-63, 50-58, 46-54, 43-51 and 35-43. These grades correspond, for example, to the grades of the bitumens subject to the specifications of Standard NF EN 12591. A bitumen of grade X/Y exhibits a penetrability at 25° C. of X.10⁻¹ to Y.10⁻¹ mm.
Category 2—Hard-grade road bitumens. By way of example, the grades belonging to this category 2 are the 10/20, 15/25 and 5/15 grades, classified according to their penetrability at 25° C. (according to the EN 1426 method) and their RBT softening points (Standard EN 1427), respectively 58-78, 55-71 and 60-76. These grades correspond, for example, to the grades of the bitumens subject to the specifications of the draft Standard NF EN 12594-1, destined to replace Standard NF EN 13924.
Category 3—Multigrade 2 road bitumens. By way of example, the grades belonging to this category 3 are the 20/30, 35/50 and 50/70 grades, classified according to their penetrability at 25° C. (according to the EN 1426 method) and their RBT softening points (Standard EN 1427), respectively 54-63, 57-66 and 63-72. These grades correspond, for example, to the grades of the bitumens subject to the specifications of the draft Standard NF EN 12594-2, destined to replace Standard NF EN 13924.
Category 4—Polymer modified bitumens. These bitumens are, for example, subject to the specifications of Standard NF EN 14023.
Category 5—Cationic emulsions of bituminous binders. These emulsions are, for example, subject to the specifications of Standard NF EN 13808.
Category 6—Fluxed or cut-back bitumens. These bitumens are, for example, subject to the specifications of Standard NF EN 15322.

The properties of the bitumens are measured according to standardized methods, namely:

The needle penetrability, measured according to Standard EN 1426. The needle penetrability is the depth, expressed in tenths of a millimetre, to which a standardized needle with a diameter of 1 mm, under a load of 100 g, applied for 5s to a bitumen sample maintained at 25° C. or at 15° C., drives into the sample.

The ring and ball (RBT) softening point according to Standard EN 1427 is a second fundamental characteristic of a bitumen: a small steel ball weighing 3.5 g and with a diameter of 9.5 mm is placed on a bitumen disk cast beforehand in a ring with an internal diameter of 19.8 mm, itself placed on a standardized support. The combined assembly is introduced in a water bath, the initial and stabilized temperature of which is 5° C. The lower face of the bitumen ring occurs at 25.4 mm from the upper surface of the plate of the bottom of the support, which corresponds to the distance which the ball falls during the test. The bath is heated at a constant rate of 5° C./min, with stirring, and the ring and ball softening point (often denoted RBT) is the temperature at which the bitumen pocket, formed during the fall of the ball, touches the reference plate placed (as has been said) at 25.4 mm under the bitumen ring. In this test, the higher the softening point, the harder the bitumen.

The Pfeiffer penetration index (PI), according to Standard NF EN 12591, makes it possible to determine the thermal susceptibility of a bitumen. The PI is calculated by means of a formula from the value of the penetrability at 25° C. and from the RBT value of a given bitumen. The result is expressed without dimensions.

The Fraass breaking point (Fraass), according to Standard NF EN 12593, evaluates the weakness of the bitumen at low temperature. A bitumen sample is spread over a steel strip according to a uniform thickness. This strip is subjected to continual cooling and repeatedly flexed until the binder layer cracks. The temperature at which the first cracking appears is denoted as the Fraass breaking point.

The flash point (Cleveland method) according to Standard NF EN ISO 2592 determines the flash and fire points of petroleum products using the open cup Cleveland tester. It is applied to petroleum products for which the open cup flash point is greater than 79° C., except for fuel oils. The test cup is filled with the test sample up to a specified level. The temperature of the test sample is increased rapidly and then more slowly and uniformly when it approaches the flash point. At specified temperature intervals, a small flame is passed above the test cup. The flash point at ambient atmospheric pressure is the lowest temperature at which the passage of the flame brings about the ignition of the vapours above the surface of the liquid. For the determination of the fire point, the test is continued until the passage of the flame brings about the ignition and then the combustion of the test sample for at least 5 s. The flash and fire points obtained at ambient atmospheric pressure are corrected to standard atmospheric pressure using an equation. The result is expressed in degrees Celsius.

The measurement of solubility according to Standard NF EN 12592 determines the degree of solubility, in a specific solvent, of bitumens having little or no inorganic matter other than that recovered from bituminous mixes. Toluene is used as solvent for the reference tests. A bitumen sample is dissolved in a solvent. This solution (containing the dissolved sample) is filtered through a layer of glass powder in a sintered glass crucible. The insoluble product is washed, then dried and weighed. The result is expressed as percentage by weight of soluble matter.

The dynamic viscosity at 60° C. (DV60) according to Standard NF EN 12596 determines the dynamic viscosity of a bitumen using vacuum capillary viscometers at 60° C., in the interval 0.0036 Pa.s to 580 000 Pa.s. The time necessary for a fixed volume of liquid to flow through a capillary by vacuum suction and under strictly controlled conditions of vacuum and temperature is determined. The viscosity is calculated by multiplying the flow time in seconds by the calibration factor of the viscometer. The result is expressed in Pa.s.

The kinematic viscosity at 135° C. (KV135) according to Standard NF EN 12595 determines the kinematic viscosity of a bitumen at 135° C., in the interval from 6 mm²/s to 300 000 mm²/s. The time necessary for a fixed volume of liquid to flow through a calibrated glass capillary viscometer under a reproducible hydrostatic head at a meticulously controlled temperature is determined (flow time). The kinematic viscosity is calculated by multiplying the flow time in seconds by the calibration factor of the viscometer. The result is expressed in mm²/s.

The test of resistance to hardening under the effect of heat and air, RTFOT (“Rolling Thin Film Oven Test”) method according to Standard NF EN 12607-1, makes it possible to measure the combined effects of heat and air on a thin continuously renewing bitumen film. It simulates the hardening which a bitumen undergoes during the mixing in a bituminous mixing plant. A continuously renewing bitumen film is heated in an oven at a prescribed temperature for a given period and under continuous flushing with air. The effects of heat and air are determined from the variation in weight of the sample (expressed as percentage) or from the change in the characteristics of the bituminous binder, such as the penetrability (EN 1426), the ring and ball softening point (EN 1427) or the dynamic viscosity (EN 12596), measured before and after passing through the oven.

Slurry-phase (in form of a suspension) hydroconversion process: The slurry-phase process or slurry technology process used for the hydroconversion of heavy hydrocarbon fractions is a process known to a person skilled in the art. Residue hydroconversion techniques in a slurry use a catalyst dispersed in the form of very small particles, the size of which is below 500 μm, preferably from 1 to 200 nm, more particularly from 1 to 20 nm for the fat-soluble precursors. The catalysts or their precursors are injected with the feedstock to be converted at the inlet of the reactors. The catalysts pass through the reactors with the feedstocks and the products in the course of conversion and then they are entrained with the reaction products out of the reactors. They are re-encountered after separation in the heavy residual fraction. The catalysts used in slurry are generally sulphur-comprising catalysts preferably comprising at least one element chosen from the group formed by Mo, Fe, Ni, W, Co, V, Cr and/or Ru; these elements can be coupled in order to form bimetallic catalysts. In this type of process, the catalysts used are generally unsupported catalysts, that is to say that the active phase is not deposited on the (porous) surface of a solid support but is well dispersed directly in the feedstock. The catalyst is generally provided in a non-active form; reference is made to precursor. The sulphurization of the catalytic metal present in the precursor makes it possible to obtain the metal sulphides forming the active phase of the catalysts. The precursors are generally conventional chemicals (metal salt, phosphomolybdic acid, sulphur-comprising compounds, organometallic compounds or natural ores), which are converted into active catalyst in situ in the reactor or else in pretreatment plants forming an integral part of the slurry-phase hydroconversion process. The precursors are, for example, octoates, naphthenates, metallocenes, oxides or crushed ores.

The catalyst can be used in just one pass or in recycle mode.

When the catalyst is in a non-active form, that is to say in the form of a precursor, it can be in the fat-soluble, water-soluble or solid (inorganic) form. Such precursors and catalysts which can be used in the process according to the invention are widely described in the literature.

By way of example, the amounts of catalyst which can be added to the feedstock, whether in “one pass” or recycle mode, are specified in Table 1 below.

TABLE 1

| | Mo | Fe |
|---|---|---|
| Fat-soluble | 50 to 6000 ppm | 1000 ppm to 1% |
| | (by weight) | (by weight) |
| Water-soluble | 300 to 6000 ppm | 1500 ppm to 2% |
| | (by weight) | (by weight) |
| Solid (inorganic) | 300 to 6000 ppm | 0.5% to 2% |
| | (by weight) | (by weight) |

The slurry-phase hydroconversion process operates under very severe conditions in order to be able to convert complex feedstocks. These are hydrocarbon feedstocks having an H/C ratio of at least 0.25. Thus, the hydrocarbon feedstocks which can be treated by this process can be chosen from: atmospheric residues and vacuum residues, deasphalting plant residues, deasphalted oils, visbroken (thermal cracking) effluents, 350° C.+ heavy effluents from an FCC (Fluid Catalytic Cracking) plant, including the FCC slurry, shale oils, biomass, coal, petroleum coke from a delayed coking plant, or mixtures of one or more of these products. Other starting materials can also be cotreated with the petroleum residues: tyres, polymers or road bitumens.

The process normally operates at temperature conditions of between 400 and 500° C. (limits included) and preferably between 410 and 470° C. (limits included). The hydrogen pressure is generally from 90 to 250 bar, preferably from 100 to 170 bar. The hourly liquid space velocity, expressed in h⁻¹, which corresponds to the ratio of the flow rate of the feedstock to the reaction volume, is, for example, between 0.05 and 1.5 h⁻¹ (limits included).

This process can be carried out in one or more reactors, in series or in parallel, which can be of different types, for example an isothermal bubble column reactor.

Such a slurry-phase hydroconversion process can comprise, after a hydroconversion stage in at least one reactor comprising a slurry catalyst comprising at least one metal, a stage of separation of the hydroconversion effluent. This separation stage comprises three substages:
First substage: the effluent from the hydroconversion stage is separated into a C6⁻ cut and a C6⁺ cut at high temperature, approximately 300° C., and high pressure, approximately 150 bar, for example in a distillation column.
Second substage: the C6⁺ cut recovered in the preceding stage is separated into a 350° C.⁻ cut and a 350° C.⁺ cut at atmospheric pressure and at high temperature, approximately 300° C., for example in a distillation column.
Third substage: the 350° C.⁺ cut recovered in the preceding stage is separated into a 525° C.⁻ cut and a 525° C.⁺ cut by vacuum distillation at high temperature, for example greater than 300° C. The 525° C.⁺ cut corresponds to the final slurry residue, used in the present invention.

Slurry residue: The slurry residue within the meaning of the invention is the final vacuum residue resulting from a slurry-phase hydroconversion process as described above.

The severity of the operations of the slurry-phase hydroconversion process results in the production of the essentially unconverted products known as “slurry residues”. The said residues are composed of highly complex molecules. A normal elemental composition of a final slurry residue is as follows:
carbon: 84%-87% (by weight)
hydrogen: 7%-14% (by weight)
heteroelements: sulphur from 2% to 6% (weight), nitrogen from 0.5% to 2% (weight)
metals: nickel and vanadium: 40 to 2000 ppm (weight)
and optionally other elements in the form of traces.

The majority of the molecules exhibit aromatic ring groups (comprising at least six rings) optionally connected by paraffin chains. They can comprise more than 60% of carbon in unsaturated chains. The H/C atomic ratio is thus low.

The said slurry residues normally correspond to the 525° C.⁺ cut of the effluent resulting from a slurry-phase hydroconversion process. They are essentially composed of two families of compounds: malthenes and asphaltenes, obtained by SARA fractionation. This fractionation consists in separating the constituents of the oil into four fractions: the Saturates, the Aromatics, the Resins and the Asphaltenes. Their proportion can vary as a function of the origin of the crude oil. By way of example, a slurry residue may contain from 15 to 50 wt % of asphaltenes. The slurry residues used in the present invention thus do not necessarily result from the slurry-phase hydroconversion of crude oil homologated to produce bitumen but from the treatment of any crude oil.

The slurry residue obtained can comprise between 0.05% and 5% (weight) of catalyst fines. It is possible to filter the slurry residue with filters of 0.8 to 3 μm. After filtration, the residue can then comprise from 0% to 0.25% (weight) of catalyst fines.

The slurry residue used in the present invention can be the 525° C.⁺ cut of the effluent resulting from a slurry-phase hydroconversion process, also known as final slurry vacuum residue or slurry VR optionally filtered.

As known from the man skilled in the art, a slurry residue as defined above thus presents a chemical composition and physicochemical properties and rheological properties different from those of residues such as residues from atmospheric distillation, residues from vacuum distillation, residues from visbreaking or residues from catalytic cracking.

In particular, residues from atmospheric distillation or from vacuum distillation are issued from separation processes during which the molecules are not subject (or a little) to a transformation. Atmospheric residues or vacuum residues issued from distillation of crude oil may contain from 2 to 25wt % of asphaltenes.

Visbroken residues, more precisely visbroken vacuum residues, are residues issued from vacuum distillation of products resulting from a visbreaking process. It is known that by visbreaking is meant a treatment of heavy hydrocarbon feedstocks which comprises placing said feedstocks in the liquid state into a furnace at a temperature sufficient to cause the heaviest hydrocarbons to crack. The cracking reaction can continue into a maturation device, wherein, without additional heating, the feedstocks travel at a rate such that at the prevailing temperature they have a sufficient residence time for achieving the desired cracking of the heavy molecules into lighter molecules. The temperature is generally about 400-500° C. and the pressure about 2 to 30.10⁵ Pascal. The cracking results in a reduction in viscosity of the treated feedstock. The cracked products, including any gaseous products that may have formed, are directed to a fractionation unit for atmospheric distillation followed by vacuum distillation. A visbroken residue may contain from 10 to 30 wt % of asphaltenes.

Residues from catalytic cracking, such as a FCC process (“Fluid Catalytic Cracking”) are issued from processes in which the molecules are cracked in lighter molecules in presence of a catalyst specific for cracking and eventually of dihydrogen. The FCC process usually operates under temperature conditions from 480 to 540° C. and pressure conditions from 2 to 3 bar. The 350° C.⁺ cut may contain from 0.1 to 8wt % of asphaltenes.

### DETAILED DESCRIPTION OF THE INVENTION

Other advantages and characteristics will emerge more clearly from the description which will follow and for which specific embodiments of the invention are given as non-limiting examples.

The present invention consists in providing a composition formed of bitumen base comprising a conventional bitumen base (other than a slurry residue) mixed with a slurry residue.

According to the invention, a composition formed of bitumen bases is prepared which comprises at least:

a. from 70% to 99% by weight of at least one bitumen base having a penetrability at 25° C. of less than or equal to 220.10⁻¹ mm and a softening point of greater than or equal to 35° C.

b. from 1% to 30% by weight of at least one slurry residue resulting from a slurry-phase hydroconversion process, the said slurry residue having a penetrability at 25° C. of less than or equal to 50.10⁻¹ mm and a softening point of greater than or equal to 50° C.

The slurry residue defined in b) can exhibit a penetrability at 25° C. of greater than or equal to 5.10⁻¹ mm and a softening point of less than or equal to 90° C.

Advantageously and non-limitingly, the composition formed of bitumen bases according to the invention can comprise at least:

a. from 75% to 99% by weight of at least one bitumen base as defined in a) above;

b. from 1% to 25% by weight of at least one slurry residue as defined in b) above.

The composition formed of bitumen bases according to the invention can comprise at least:

a. from 85% to 99% by weight of at least one bitumen base as defined in a) above;

b. from 1% to 15% by weight of at least one slurry residue as defined in b) above.

The slurry residue or residues defined in b) can comprise catalyst fines (catalyst particles) in a variable content. Generally, the content observed is from 0.05% to 5% by weight and can be reduced, for example, from 0% to 0.25% by weight, for example as a result of a filtration or any other treatment which makes it possible to separate the catalyst particles from a slurry residue.

Advantageously, the composition formed of bitumen bases can comprise from 1% to 30% by weight, for example from 1% to 25% by weight, of at least one slurry residue exhibiting a content of catalyst particles of 0% to 3% by weight.

Advantageously, the composition formed of bitumen bases can comprise from 1% to 15% by weight of at least one slurry residue exhibiting a content of catalyst particles of 0% to 5% by weight.

The sum of the percentages by weight of the bitumen bases defined in a) and b) can be equal to 100%. In other words, the composition formed of bitumen bases according to the invention can be composed of one or more bitumen bases as defined in a) and of one or more slurry residues as defined in b). In particular, the composition formed of bitumen bases according to the invention can be composed of a single bitumen base as defined in a) and of a single slurry residue as defined in b).

The bitumen base mentioned in a) can be a normal bitumen base produced by refining a crude oil homologated to produce bitumen, as described above. In other words, the said at least one bitumen base defined in a) can be a base resulting from the atmospheric distillation and/or vacuum distillation of crude oil, in particular of a crude oil homologated to produce bitumen.

The slurry residue mentioned in b) is a slurry residue as described above. It is in particular a final vacuum residue of a slurry-phase hydroconversion process. It can thus result from a process for the slurry-phase hydroconversion of a feedstock having an H/C ratio of at least 0.25, the said process operating at temperature conditions of 400° C. to 500° C., with a hydrogen pressure of 90 to 250 bar and HSV of 0.05 to 1.5 h⁻¹, a catalyst comprising at least one metal being added in the precursor form and dispersed in the feedstock. A separation in three stages as described above can make it possible to recover the said slurry residue (final vacuum residue).

The composition formed of bitumen bases according to the invention can be produced by simple mixing of the bitumen bases defined in a) and b), in particular with stirring, at a temperature sufficient to ensure a homogeneous mixture of these bases. This temperature is generally greater by 80° C. than the softening point of each of the bases (bitumen base and slurry residue).

The said at least one bitumen base defined in a) can exhibit a penetrability at 25° C. of from 5.10⁻¹ to 220.10⁻¹ mm, for example from 10.10⁻¹ to 100.10⁻¹ mm or from 35.10⁻¹ to 100.10⁻¹ mm.

Whatever its penetrability, the said at least one bitumen base defined in a) can exhibit a softening point of greater than or equal to 35° C., as already mentioned, for example of greater than or equal to 43° C., indeed even greater than or equal to 50° C. In particular, the softening point can be from 35° C. to 78° C., for example from 43° C. to 78° C. or from 43° C. to 58° C. or from 58° C. to 78° C.

In particular, the said at least one bitumen base defined in a) can exhibit the following characteristics:
a penetrability at 25° C. of 5.10⁻¹ to 70.10⁻¹ mm and a softening point of greater than or equal to 54° C., for example of 54° C. to 78° C. By way of example, the penetrability at 25° C. can be from 15.10⁻¹ to 25.10⁻¹ mm and the softening point can be greater than or equal to 55° C., for example from 55° C. to 71° C.; or also the penetrability at 25° C. can be from 10.10⁻¹ to 20.10⁻¹ mm and the softening point can be greater than or equal to 58° C., for example from 58° C. to 78° C.; or also a penetrability at 25° C. can be from 5.10⁻¹ to 15.10⁻¹ mm and the softening point can be greater than or equal to 60° C., for example from 60° C. to 76° C.; or also the penetrability at 25° C. can be from 20.10⁻¹ to 30.10⁻¹ mm and the softening point can be greater than or equal to 54° C., for example from 54° C. to 63° C.; or also the penetrability at 25° C. can be from 35.10⁻¹ to 50.10⁻¹ mm and the softening point can be greater than or equal to 57° C., for example from 57° C. to 66° C.; or also the penetrability at 25° C. can be from 50.10⁻¹ to 70.10⁻¹ mm and the softening point can be greater than or equal to 63° C., for example from 63° C. to 72° C.; or
a penetrability at 25° C. of 35.10⁻¹ to 50.10⁻¹ mm and a softening point of greater than or equal to 50° C., for example from 50° C. to 58° C., or
a penetrability at 25° C. of 70.10⁻¹ to 100.10⁻¹ mm and a softening point of greater than or equal to 43° C., for example from 43° C. to 51° C.

The said at least one bitumen base defined in a) can in particular belong to one of the bitumen categories 1 to 3 defined above.

The invention also relates to the use of a residue resulting from a hydroconversion process in a slurry reactor as bitumen base for a road bitumen.

For example, a process for the preparation of a bitumen base for a road bitumen can comprise:
a stage of treatment of a crude oil by a slurry-phase hydroconversion process in at least one reactor,
a stage of separation, in particular in three substages, of an effluent exiting from the said at least one reactor in order to separate a slurry residue,
a stage of recovery of the slurry residue.

As described above, the slurry residue then forms a bitumen base which can be used to produce a road bitumen.

### EXAMPLES

For the record, throughout the present patent application, the following properties of the bases are measured as indicated in Table 2 below:

TABLE 2

| | | | Measurement |
|---|---|---|---|
| Property | Abbreviation | Unit | standard |
| Needle | P25 | 1/10 mm | EN 1426 |
| penetration at | | | |
| 25° C. | | | |
| Ring and ball | RBT | ° C. | EN 1427 |
| softening | | | |
| temperature | | | |
| Fraass breaking | Fraass | ° C. | EN 12593 |
| point | | | |
| Kinematic | KV135 | mm²/s | EN 12595 |
| viscosity at | | | |
| 135° C. | | | |
| Dynamic | DV60 | Pa · s | EN 12596 |
| viscosity at 60° C. | | | |
| Pfeiffer index | PI | without | EN 12591 |

### Bitumen Bases

Base A: Hard base grade 20/30, the properties of which appear in Table 3 below:

TABLE 3

| Characteristics | Values |
|---|---|
| P25 | 18 |
| RBT | 61.4 |
| Fraass | 0 |
| PI | −0.8 |

Base B: Slurry residue (VR Slurry)

A vacuum residue resulting from the vacuum distillation of a Ural crude is mixed with catalyst based on molybdenum and hydrogen upstream of an oven in which it is heated. The mixture is subsequently sent to a perfectly stirred reactor where the slurry-phase conversion reaction is continued. A separation in three stages, as described above, is carried out so as to obtain the final vacuum residue, which corresponds to the 525° C.⁺ cut.

The analysis of the slurry residue obtained is described in detail in Tables 4 and 5 below:

TABLE 4

| | Unit | Value |
|---|---|---|
| Xylene insolubles | % | <3% |
| Density 15° C. | kg/m³ | 1087.8 |
| Softening point T° C. | ° C. | 68.2 |
| Viscosity 135° C. | mm²/S | 1103 |
| Viscosity 150° C. | mm²/S | 496 |
| Hydrogen | % w | 9 |
| Carbon | % w | 86.4 |
| Oxygen | % w | 0.71 |
| Sulphur | % w | 2.3 |

TABLE 5

| Characteristics | Values |
|---|---|
| P25 | 10 |
| RBT | 69 |
| Fraass | 11 |
| PI | −0.51 |

Base C: Soft base grade 160/220, the characteristics of which appear in Table 6 below.

TABLE 6

| Characteristics | Values |
|---|---|
| P25 | 185 |
| RBT | 39.6 |
| Fraass | <-15 |
| PI | −0.55 |

Base D : vacuum residue, corresponding to a base of grade 10/20, the characteristics of which are collected in below table 7.

TABLE 7

| Characteristics | Values |
|---|---|
| P25 | 14 |
| TBA | 64.1 |
| Fraass | −1 |
| IP | 0.83 |
| VC135 | 1882 |
| Solubility(% masse) | 100 |
| Cleveland Eclair | 374 |
| Point (° C.) | |

Production of the Mixture of the Bases A and B: Preparation of a Composition Formed of Bitumen Bases

Before mixing, the bases A and B are preheated in a ventilated oven at 140° C. The preheating time is estimated at 1 h 30 for 1 kg of base in order to obtain a fluid and homogeneous base.

In order to produce each of the mixtures, 500 g of the bases A and B are withdrawn while observing the weight percentages below:
Mixture 1: 25% B-75% A
Mixture 2: 50% B-50% A
Mixture 3: 75% B-25% A

The mixture is heated by a “heating mantle” system with an electrical resistance, thermostat and thermocoupled PT100 temperature probe. Stirring is carried out with a system of “Rayneri” type which is a metal centripetal turbine coupled to a stirring system provided with a system for adjusting the speed (0 to 2000 rev/min).

The mixture is heated at 160° C. with stirring (250-300 rev/min) for a duration of 45 min so as to obtain a homogeneous mixture.

Penetrability, RBT and Fraass measurements are carried out on each of the mixtures according to the standardized methods. The results are collated in Table 8.

TABLE 8

| | | Mixture 1: | Mixture 2: | Mixture 3: |
|---|---|---|---|---|
| | Mixture 0: | 25% B - | 50% B - | 75% B - |
| Characteristics | 100 A | 75% A | 50% A | 25% A |
| P25 | 18 | 13 | 11 | 10 |
| RBT | 61.4 | 63.8 | 65.2 | 67.4 |
| Fraass | 0 | NM | NM | NM |
| PI | −0.80 | −0.92 | −0.95 | −0.75 |

NM: not measured

Manufacture of a Bitumen of 35/50 Grade from the Compositions Formed of Bitumen Bases Prepared Above (Mixtures 1 to 3)

Before mixing, the base C is preheated in a ventilated oven at approximately 120° C. The preheating time is estimated at 1 h 30 per 1 kg of base in order to obtain a fluid and homogeneous base.

The mixing of the base C and of the A/B mixture is carried out similarly to the preparation of the A/B mixture.

Penetrability, RBT and Fraass measurements are carried out on each of the mixtures according to the standardized methods. The results are collated in Table 9.

TABLE 9

| | Test 1: | Test 2: | Test 3: | Test 4: |
|---|---|---|---|---|
| | Mixture 0 + | Mixture 1 + | Mixture 2 + | Mixture 3 + |
| Characteristics | 36% Base C | 44% Base C | 47% Base C | 49% Base C |
| P25 | 33 | 36 | 37 | 35 |
| RBT | 53.6 | 53 | 52.6 | 52.4 |
| Fraass | −5 | −4 | −2 | −1 |
| PI | −1.22 | −1.18 | −1.22 | −1.37 |
| KV135 | 654 | 534 | 453 | 400 |
| DV60 | 567 | 448 | 409 | 383 |
| ΔRBT after | 5.4 | 6.2 | 8.0 | 10.4 |
| RTFOT ageing | | | | |
| % VR slurry in | 0% | 14% | 26.5% | 38.25% |
| total mixture | | | | |

Test 2 shows that it is possible to incorporate VR slurry without damaging the properties of the bitumen. Specifically, these properties are in accordance with the compulsory properties expected by the EN 12591 specification both as regards to the penetrability at 25° C. and the softening point (RBT).

Likewise, it is observed that the impact on the variation in RBT after RTFOT ageing (NF EN 12607-1), which is a limiting constraint in the formulation of a bitumen, is less than or equal to 8 for Tests 2 and 3, that is to say in accordance with the EN 12591 specifications.

Even more, it is apparent that the incorporation of VR slurry has a positive impact on the kinematic viscosity at 135° C. and the dynamic viscosity at 60° C. This is because the kinematic viscosity at 135° C. decreases by 18% with 14% of VR slurry in the finished product. This decrease in the viscosity makes it possible to render the bitumen pumpable at lower temperatures and makes it possible to apply the bitumen at a lower temperature.

It is thus demonstrated that the incorporation of 525⁺ slurry residue resulting from the hydroconversion process in a slurry reactor is possible in the category 1 road grades according to Standard EN 12591.

The incorporation can thus be envisaged at a level of:
14% (by weight) approximately on taking into account the portion of catalyst fines present in the residue in order to meet the minimum specification with regard to the solubility of 99%,
25% (by weight) approximately for the road grades on reducing the amount of catalyst fines, for example by a filtration process.

Following the same reasoning, the incorporation of 525⁺ residue is also possible for the categories 2 and 3 which exhibit compulsory properties according to the NF EN 13924-1 and NF EN 13924-2 specifications which are less restricting than the category 1 defined according to Standard EN 12591.

1-10. (canceled)

11. A composition formed of bitumen bases comprising at least:
a) from 70% to 99% by weight of at least one bitumen base having a penetrability at 25° C. of less than or equal to 220.10⁻¹ mm and a softening point of greater than or equal to 35° C.; and
b) from 1% to 30% by weight of at least one slurry residue resulting from a slurry-phase hydroconversion process, the at least one slurry residue having a penetrability at 25° C. of less than or equal to 50.10⁻¹ mm and a softening point of greater than or equal to 50° C.

12. The composition according to claim 1, comprising at least:
from 75% to 99% by weight of at least one bitumen base as defined in a); and
from 1% to 25% by weight of at least one slurry residue as defined in b).

13. The composition according to claim 11, comprising at least:
from 85% to 99% by weight of at least one bitumen base as defined in a); and
from 1% to 15% by weight of at least one slurry residue as defined in b).

14. The composition according to claim 11, comprising from 1% to 30% by weight of at least one slurry residue exhibiting a content of catalyst particles of 0% to 3% by weight.

15. The composition according to claim 13, comprising from 1% to 15% by weight of at least one slurry residue exhibiting a content of catalyst particles of 0% to 5% by weight.

16. The composition according to claim 1 wherein the at least one bitumen base defined in a) is a base resulting from the atmospheric distillation and/or vacuum distillation of crude oil.

17. The composition according to claim 1 wherein the at least one slurry residue defined in b) results from a slurry-phase hydroconversion process of a feedstock having an H/C ratio of at least 0.25, the said process operating at temperature conditions of 400 to 500° C., with a hydrogen pressure of 90 to 250 bar and an HSV of 0.05 to 1.5 h⁻¹, a catalyst comprising at least one metal being added in the form of a precursor, and dispersed in the feedstock.

18. The composition according to claim 1 wherein the at least one bitumen base defined in a) exhibits a penetrability at 25° C. of from 5.10⁻¹ to 220.10⁻¹ mm, for example from 10.10⁻¹ to 100.10⁻¹ mm or from 35.10⁻¹ to 100.10⁻¹ mm.

19. The composition according to claim 1 wherein the at least one bitumen base defined in a) exhibits a softening point of greater than or equal to 43° C.

20. The composition according to claim 19 wherein the at least one bitumen base defined in a) exhibits a softening point of greater than or equal to 50° C.

20. A method comprising
using a slurry residue resulting from a slurry-reactor hydroconversion process as a bitumen base for a road bitumen, wherein the bitumen base comprises:
a) from 70% to 99% by weight of at least one bitumen base having a penetrability at 25° C. of less than or equal to 220.10⁻¹ mm and a softening point of greater than or equal to 35° C.; and
b) from 1% to 30% by weight of at least one slurry residue resulting from the slurry-phase hydroconversion process, the slurry residue having a penetrability at 25° C. of less than or equal to 50.10⁻¹ mm and a softening point of greater than or equal to 50° C.
